(19) United States
(12) Patent Application Publication
(10) Pub. No.: US 2026/0260599 A1
(43) Pub. Date: Sep. 3, 2026

(54) DISPLAY PANEL AND ELECTRONIC DEVICE

(71) Applicant: Xiamen Tianma Display Technology Co., Ltd., Xiamen (CN)

(72) Inventors: Xingyao Zhou, Xiamen (CN); Lei Wang, Xiamen (CN); Hao Chen, Xiamen (CN); Yana Gao, Xiamen (CN); Xing Lu, Xiamen (CN); Zhiqiang Xia, Xiamen (CN); Kang Yang, Xiamen (CN)

(73) Assignee: Xiamen Tianma Display Technology Co., Ltd., Xiamen (CN)

(21) Appl. No.: 19/231,540

(22) Filed: Jun. 8, 2025

(30) Foreign Application Priority Data
Feb. 28, 2025 (CN) 202510237434.1

(51) Int. Cl. G09G 3/32

(52) U.S. Cl. CPC G09G 3/32; G09G 2300/043; G09G 2300/0819; G09G 2310/0294; G09G 2310/08; G09G 2320/0219; G09G 2320/0242; G09G 2320/041

(57) ABSTRACT

The present application provides a display panel and an electronic device, and relates to the technical field of display driving. According to the technical solutions provided by the present application, the pixel driving circuit is provided with a potential holding circuit electrically connected to the first node, and the potential holding circuit can hold the potential of the first node, thereby improving the problem that the charge of the first node is transmitted to the second node through the threshold compensation transistor due to the enhancement of negative bias coupling of the threshold compensation transistor after being heated, thereby avoiding the problem that the potential of the second node is lowered, ensuring the accuracy of driving current generated by the driving transistor, improving the reliability of the pixel driving circuit, and ensuring high display effect of the display panel.

### CROSS-REFERENCE TO RELATED APPLICATION

The present application claims priority to Chinese Patent Application No. 202510237434.1 filed on February 28, 2025, and titled “DISPLAY PANEL AND ELECTRONIC DEVICE”, which is incorporated herein by reference in its entirety.

### TECHNICAL FIELD

The present application relates to the technical field of display driving, and more particularly, to a display panel and an electronic device.

### BACKGROUND

With the continuous development of science and technology, more and more electronic devices which have a display function have been widely used in people’s daily life and work, have brought great convenience to people’s daily life and work, and have become an indispensable tool for people nowadays. An important component for realizing a display function in an electronic device is a display panel. A display panel generally comprises a plurality of pixel units, and each pixel unit comprises a pixel driving circuit and a light-emitting element that are electrically connected. When a screen is displayed on the display panel, the pixel driving circuit outputs a driving current to the light-emitting element, and the light-emitting element is turned on in response to the driving current. Therefore, the reliability of the pixel driving circuit directly affects the display effect of the display panel.

### SUMMARY

In view of this, the present application provides a display panel and an electronic device.

One aspect of the present disclosure includes a display panel. The display panel includes a plurality of pixel driving circuits. The pixel driving circuits includes a driving transistor, a threshold compensation transistor, and a potential holding circuit. The driving transistor is configured for generating a driving current. A first electrode of the threshold compensation transistor is electrically connected to an output electrode of the driving transistor at a first node, a second electrode of the threshold compensation transistor is electrically connected to a gate of the driving transistor at a second node, and the gate of the threshold compensation transistor is electrically connected to a threshold compensation control signal line. The potential holding circuit is electrically connected to the first node.

Another aspect of the present disclosure includes an electronic device, which includes the above-described display panel.

### BRIEF DESCRIPTION OF THE DRAWINGS

In order to more clearly explain the technical solutions in the embodiments of the present application or the prior art, the drawings that need to be used in the description of the embodiments or the prior art will be briefly introduced below, and it is obvious that the drawings in the following description are only embodiments of the present application, and for those skilled in the art, other drawings can be obtained according to the provided drawings without making creative labor.

FIG. 1 is a schematic structural diagram of a display panel according to an embodiment of the present application;

FIG. 2 is a schematic structural diagram of a pixel driving circuit according to an embodiment of the present application;

FIG. 3 is a schematic structural diagram of a pixel driving circuit according to another embodiment of the present application;

FIG. 4 is a schematic structural diagram of a pixel driving circuit according to an embodiment of the present application;

FIG. 5 is a timing diagram according to an embodiment of the present application;

FIG. 6 is a timing diagram provided according to another embodiment of the present application;

FIG. 7 is a schematic structural diagram of a pixel driving circuit according to another embodiment of the present application;

FIG. 8 is a schematic structural diagram of a pixel driving circuit according to another embodiment of the present application;

FIG. 9 is a schematic structural diagram of a pixel driving circuit according to another embodiment of the present application;

FIG. 10 is a timing diagram according to another embodiment of the present application;

FIG. 11 is a schematic structural diagram of a display panel according to another embodiment of the present application;

FIG. 12 is a schematic structural diagram of a display panel according to another embodiment of the present application;

FIG. 13 is a part of a layout diagram of a pixel driving circuit according to an embodiment of the present application;

FIG. 14 is a schematic structural diagram of a first semiconductor layer in FIG. 13;

FIG. 15 is a schematic structural diagram of a first gate metal layer of FIG. 13;

FIG. 16 is a schematic structural diagram of a capacitor metal layer of FIG. 13;

FIG. 17 is a schematic structural diagram of a second gate metal layer of FIG. 13;

FIG. 18 is a schematic structural diagram of a second semiconductor layer of FIG. 13;

FIG. 19 is a schematic structural diagram of a source-drain metal layer of FIG. 13;

FIG. 20 is a schematic structural diagram of a wiring metal layer of FIG. 13;

FIG. 21 is a schematic structural diagram of a display panel according to another embodiment of the present application;

FIG. 22 is a schematic structural diagram of a display panel according to another embodiment of the present application;

FIG. 23 is a schematic structural diagram of a display panel according to another embodiment of the present application;

FIG. 24 is a schematic structural diagram of a display panel according to another embodiment of the present application;

FIG. 25 is a schematic structural diagram of a display panel according to another embodiment of the present application; and

FIG. 26 is a schematic structural diagram of an electronic device according to an embodiment of the present application.

### DETAILED DESCRIPTION

Hereinafter, the technical solutions in the embodiments of the present application will be clearly and completely described with reference to the accompanying drawings in the embodiments of the present application, and it is obvious that the described embodiments are only a part of embodiments of the present application, but not all the embodiments. Based on the embodiments in the present application, all other embodiments obtained by those skilled in the art without creative work fall within the scope of protection of the present application.

As described in the background art, with the continuous development of science and technology, more and more electronic devices with display functions are widely used in people's daily life and work, bringing great convenience to people's daily life and work, and become indispensable and important tools for people today. An important component for realizing a display function in an electronic device is a display panel. A display panel generally comprises a plurality of pixel units, and each pixel unit comprises a pixel driving circuit and a light-emitting element that are electrically connected. When a screen is displayed on the display panel, the pixel driving circuit outputs a driving current to the light-emitting element, and the light-emitting element is turned on in response to the driving signal current. Therefore, the reliability of the pixel driving circuit directly affects the display effect of the display panel.

In view of this, embodiments of the present application provide a display panel and an electronic device, which effectively solve technical problems existing in the prior art, improve reliability of the pixel driving circuit, and ensure high display effect of the display panel.

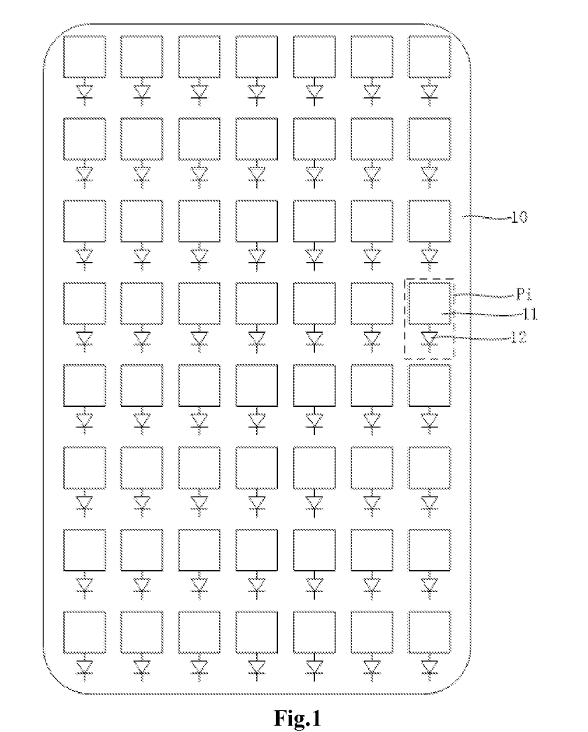

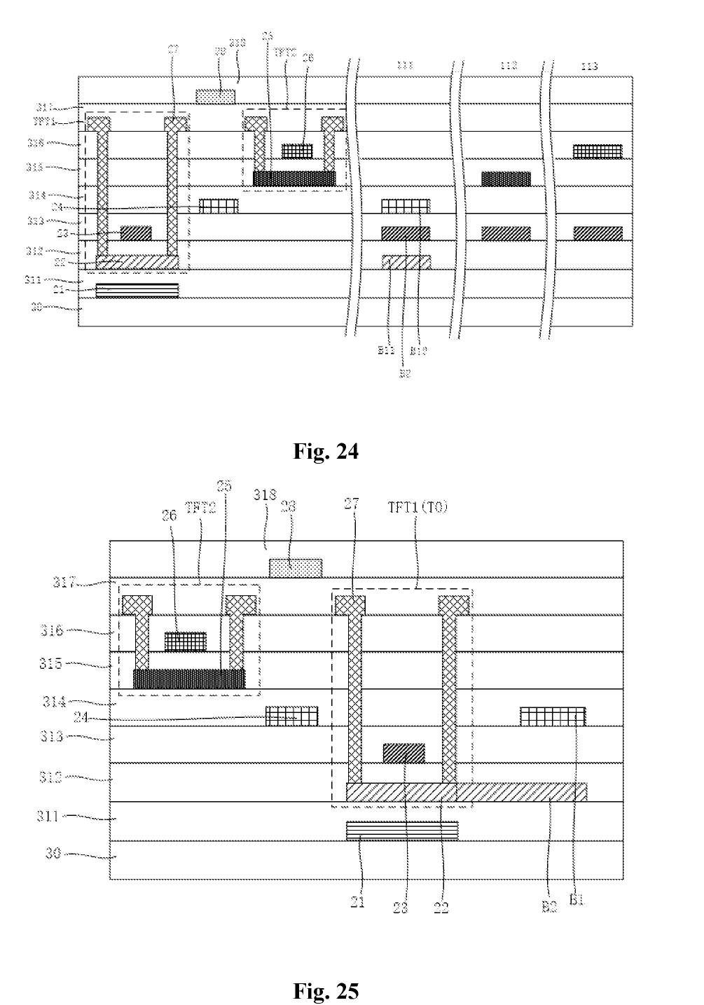

In order to achieve the above object, the technical solutions provided by the embodiments of the present application are as follows, and the technical solutions provided by the embodiments of the present application are described in detail with reference to FIGS. 1 to 26.

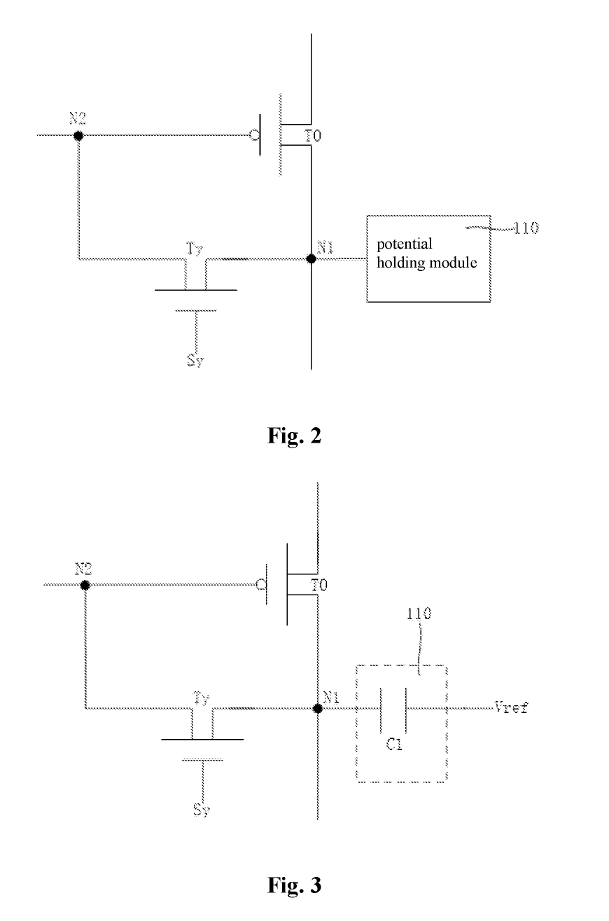

Referring to FIGS. 1 and 2, FIG. 1 is a schematic structural diagram of a display panel provided by an embodiment of the present application, and FIG. 2 is a schematic structural diagram of a pixel driving circuit provided by an embodiment of the present application. The display panel 10 provided by the embodiments of the present application comprises a plurality of pixel units Pi, each pixel unit Pi comprises a pixel driving circuit 11, and at least one light-emitting element 12 electrically connected to the pixel driving circuit 11, and the light-emitting element 12 may be a light-emitting diode. The pixel driving circuit 11 comprises: a driving transistor T0 configured for generating a driving current; a threshold compensation transistor Ty, a first electrode of which is electrically connected to an output electrode of the driving transistor T0 at a first node N1, a second electrode of which is electrically connected to a gate of the driving transistor T0 at a second node N2, and a gate of which is electrically connected to a threshold compensation control signal line Sy; and a potential holding circuit 110 electrically connected to the first node N1.

It can be understood that the pixel driving circuit 11 will control the threshold compensation transistor Ty to be turned off after completing the writing of the data voltage, and the threshold compensation transistor Ty will be heated due to the effect of conditions such as long-term operation and/or environmental factors. When the threshold compensation transistor Ty is heated, the negative bias coupling of the threshold compensation transistor Ty is enhanced; thus when the threshold compensation transistor Ty is turned off, the charge of the first node N1 is transmitted to the second node N2 through coupling of the threshold compensation transistor Ty, thus lowering the potential of the second node N2. The potential of the second node N2 directly affects the magnitude of the driving current generated by the driving transistor T0. Therefore, when the potential of the second node N2 is lowered, the driving current generated by the driving transistor T0 deviates, causing a problem of display color shift and degrading the display effect of the display panel. According to the technical solutions provided by the embodiments of the present application, the pixel driving circuit 11 is provided with a potential holding circuit 110 electrically connected to the first node N1, and the potential holding circuit 110 can hold the potential of the first node N1, thereby improving the problem that the charge of the first node N1 is transmitted to the second node N2 through the threshold compensation transistor Ty coupling due to the enhanced negative bias coupling of the threshold compensation transistor Ty after being heated, thereby avoiding the problem that the potential of the second node N2 is lowered, ensuring the accuracy of the driving current generated by the driving transistor T0, improving reliability of the pixel driving circuit, and ensuring high display effect of the display panel.

In some embodiments, the potential holding circuit 110 provided by the embodiments of the present application may use a capacitor to achieve a potential holding effect on the first node N1. Specifically, FIG. 3 is a schematic structural diagram of a pixel driving circuit provided by another embodiment of the present application, the potential holding circuit 110 provided by the embodiments of the present application comprises a potential holding capacitor C1, a first plate of the potential holding capacitor C1 is electrically connected to a reference voltage line Vref, and a second plate of the potential holding capacitor C1 is electrically connected to the first node N1. The reference voltage line Vref provided in the embodiments of the present application is used to provide a fixed voltage, and may be a newly added voltage line in the display panel, or may reuse an original voltage line in the display panel. Optionally, the reference voltage line Vref provided in the embodiments of the present application may be a power supply voltage line (such as a first power supply voltage line PVDD and a second power supply voltage line PVEE), a reset voltage line (such as a first reset voltage line REF1 and a second reset voltage line REF2), a bias voltage line DVH, or the like, and the present application does not specifically limit this.

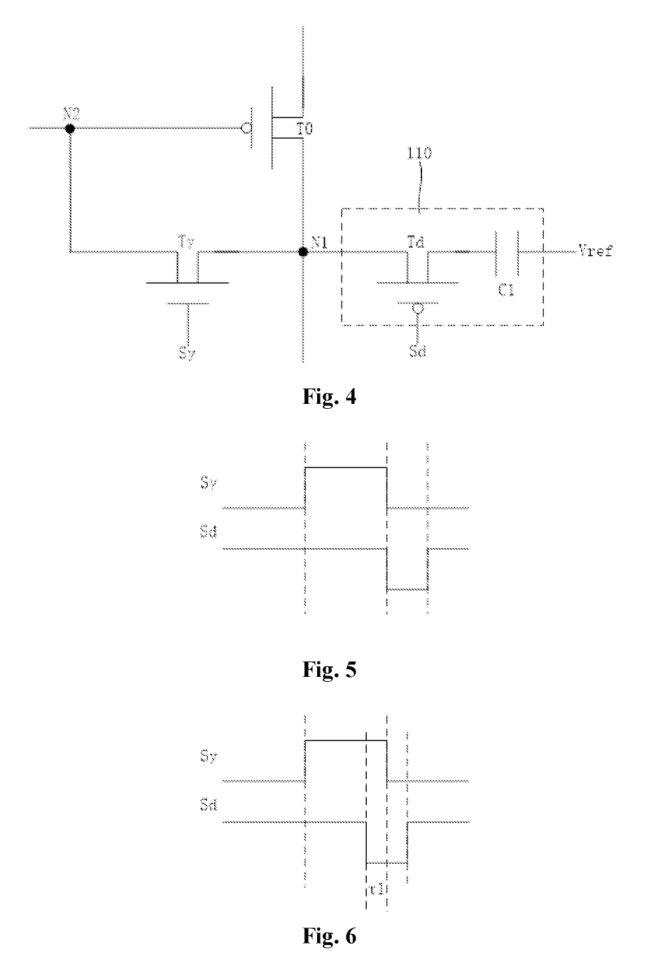

Referring to FIG. 4, which is a schematic structural diagram of a pixel driving circuit provided by another embodiment of the present application, the potential holding circuit 110 provided by the embodiments of the present application further comprises a potential holding transistor Td, a first electrode of which is electrically connected to the second plate of the potential holding capacitor C1, a second electrode of which is electrically connected to the first node N1, and a gate of which is electrically connected to a potential holding control signal line Sd. When the potential holding capacitor C1 is required to hold the potential of the first node N1, the potential holding control signal line Sd controls the potential holding transistor Td to be turned on, thereby communicating the potential holding capacitor C1 with the first node N1, avoiding the potential interference of the potential holding capacitor C1 with the first node N1 in other stages, and improving the reliability of the pixel driving circuit 11. In an embodiment, the potential holding capacitor C1 provided in the embodiment of the present application needs to hold the potential of the first node N1 after the threshold compensation transistor Ty completes the threshold compensation; therefore, while the threshold compensation control signal line Sy controls the threshold compensation transistor Ty to complete the threshold compensation and then to be turned off, the potential holding control signal line Sd controls the potential holding transistor Td to be turned on. In conjunction with FIG. 5, which is a timing diagram provided by an embodiment of the present application, taking an example that the threshold compensation transistor Ty illustrated in FIG. 4 is an N-type transistor and the potential holding transistor Td is a P-type transistor, when the threshold compensation control signal line Sy jumps to a low level to control the threshold compensation transistor Ty to be turned off, that is, when the potential holding control signal line Sd jumps to a low level to control the potential holding transistor Td to be turned on, the threshold compensation transistor Ty is turned off, and meanwhile the potential holding transistor Td is turned on, thereby preventing the potential holding capacitor C1 from affecting the process of threshold compensation. Or in another embodiment, in order to ensure the timeliness of potential holding of the first node N1 after the threshold compensation, within a first preset time t1 before the threshold compensation control signal line Sy controls the threshold compensation transistor Ty to complete the threshold compensation and be turned off, the potential holding control signal line Sd controls the potential holding transistor Td to be turned on. Specifically, in conjunction with FIG. 6, which is a timing diagram provided by another embodiment of the present application, similarly, taking an example that the threshold compensation transistor Ty illustrated in FIG. 4 is an N-type transistor and the potential holding transistor Td is a P-type transistor, within the first preset time t1 before the threshold compensation control signal line Sy jumps to a low level to control the threshold compensation transistor Ty to be turned off, the potential holding control signal line Sd jumps to a low level to control the potential holding transistor Td to be turned on, avoiding the problem that the potential holding capacitor C1 fails to control the potential of the first node N1 in time, and reducing, by optimizing the duration of the first preset time t1, the impact of the potential holding capacitor C1 on the potential of the first node N1 during threshold compensation in this time period to a negligible level, thereby enhancing reliability of the pixel circuit 11.

Similarly, in order to prevent the potential holding capacitor C1 from affecting the potential of the first node N1 when the light-emitting element 12 is turned on, the potential holding control signal line Sd controls the potential holding transistor Td to be turned off while the pixel driving circuit 11 drives the electrically connected light-emitting element 12 to emit light. Alternatively, in the second preset time before the pixel driving circuit 11 drives the light-emitting element 12 to emit light, the potential holding control signal line Sd controls the potential holding transistor Td to be turned off, thereby realizing the control process of turning off the potential holding transistor Td first and then turning on the light-emitting element 12, which can more effectively avoid the problem that the potential holding capacitor C1 affects the potential of the first node N1 when the light-emitting element 12 is turned on. Moreover, by optimizing the duration of the second preset time, the problem of the charge transmission from the first node N1 to the second node N2 through coupling of the threshold compensation transistor Ty in this time period is minimized to be ignorable, which improves the reliability of the pixel drive circuit 11.

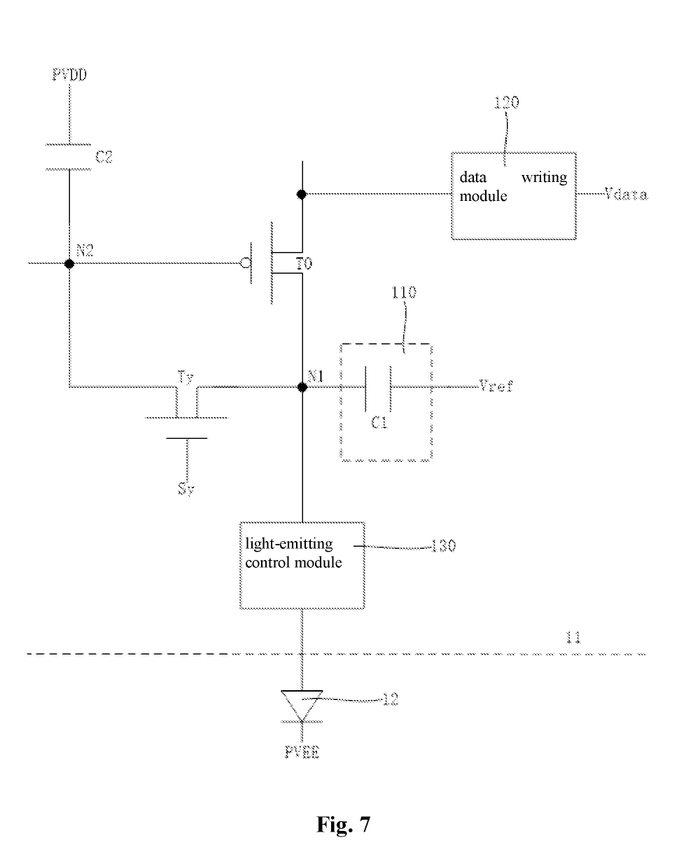

In some embodiments, the pixel driving circuit 11 provided by the embodiments of the present application further comprises circuit structures such as a capacitor, a data writing circuit, a reset control circuit, and a light emitting control circuit, thereby realizing lighting control of the light-emitting element 12 by the pixel driving circuit 11. Hereinafter, the pixel driving circuit 11 applicable to the embodiments of the present application will be described in more detail with reference to the drawings. Referring to FIG. 7, which is a schematic structural diagram of a pixel driving circuit provided by another embodiment of the present application, the pixel driving circuit provided by the embodiment of the present application comprises a storage capacitor C2, a first plate of the storage capacitor C2 is electrically connected to a first power supply voltage line PVDD, and a second plate of the storage capacitor C2 is electrically connected to the gate of the driving transistor T0 (that is, the second plate of the storage capacitor C2 is electrically connected to a second node N2). The pixel driving circuit further comprises a data writing circuit 120 electrically connected to an input electrode of the driving transistor T0 and transmitting a data voltage transmitted by a data voltage line Vdata to the driving transistor T0; and a light-emitting control circuit 130 electrically connected in series with the driving transistor T0 and controlling the transmission of the driving current to the light-emitting element 12.

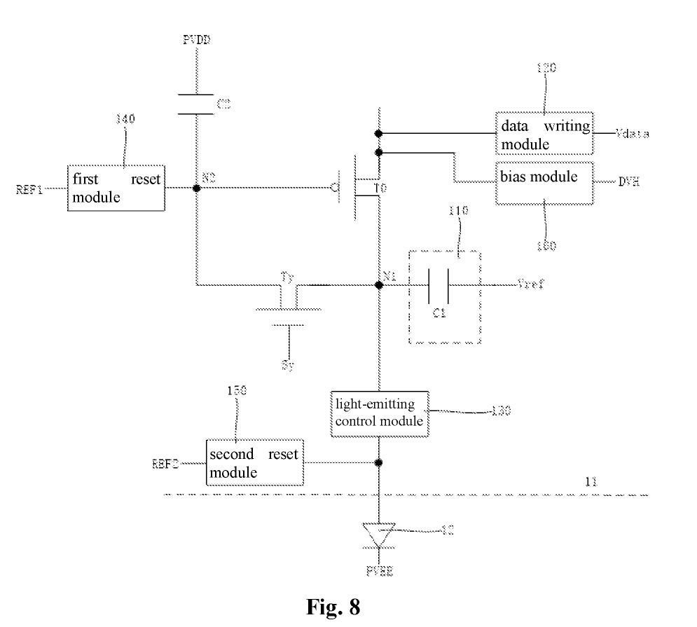

Further referring to FIG. 8, which is a schematic structural diagram of a pixel driving circuit provided by another embodiment of the present application, the pixel driving circuit 11 provided by the embodiment of the present application further comprises a first reset circuit 140 electrically connected to the gate of the driving transistor T0 (that is, the first reset circuit 140 is electrically connected to the second node N2), the first reset circuit 140 transmits the first reset voltage transmitted by the first reset voltage line REF1 to the gate of the driving transistor T0, thereby resetting the potential of the gate of the driving transistor T0, ensuring high accuracy of subsequent control of the driving transistor T0, and improving reliability of the pixel driving circuit 11.

As shown in FIG. 8, the pixel driving circuit 11 according to the embodiments of the present application further comprises a second reset circuit 150 electrically connected to the anode of the light-emitting element 12, the light-emitting element 12 may be a light-emitting diode, and the cathode of the light-emitting element 12 is electrically connected to the second power supply voltage line PVEE. The second reset circuit 150 transmits the second reset voltage transmitted by the second reset voltage line REF2 to the light-emitting element 12, thereby realizing the purpose of resetting the anode of the light-emitting element 12, avoiding the problem that the light-emitting element 12 is turned off but not darkened, which further improves the reliability of the pixel driving circuit 11. Furthermore, the pixel driving circuit 11 according to the embodiments of the present application further comprises a bias circuit 160 electrically connected to the input electrode of the driving transistor T0, the bias circuit 160 transmits the bias voltage transmitted by the bias voltage line DVH to the driving transistor T0 to adjust a bias state of the driving transistor T0 in a bias stage, so that the driving transistor T0 is reversely biased, the degree of ion polarization inside the driving transistor T0 is reduced, and the driving transistor T0 is compensated for the threshold voltage drift caused by the hysteresis effect of the driving transistor T0 working in a positive bias state for a long time, and the display effect of the display panel is improved.

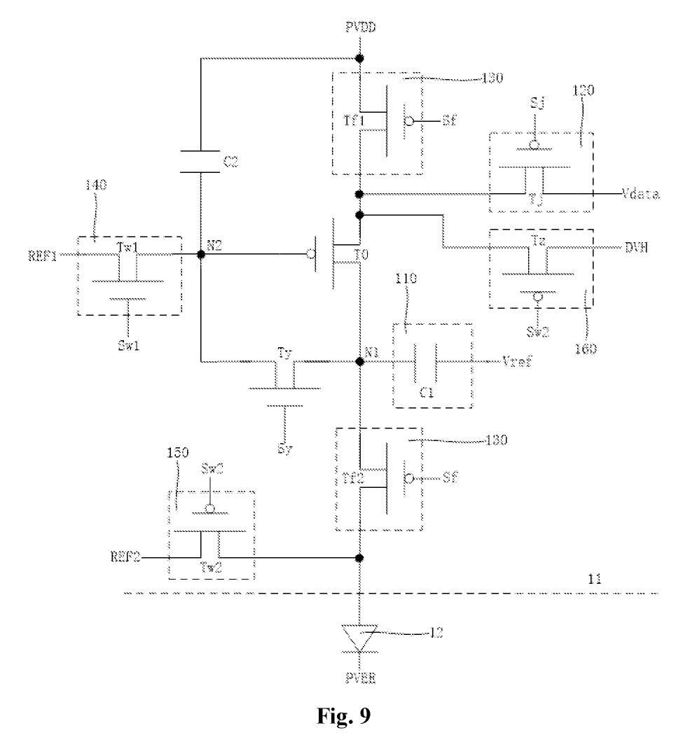

In some embodiments, the data writing circuit 120, the light-emitting control circuit 130, the first reset circuit 140, the second reset circuit 150, and the bias circuit 160 provided in the embodiments of the present application can each realize related functions by means of transistors. Specifically, referring to FIG. 9, which is a schematic structural diagram of a pixel driving circuit provided by another embodiment of the present application, the data writing circuit 120 provided by the embodiment of the present application comprises a data writing transistor Tj, a first electrode of the data writing transistor Tj is electrically connected to a data voltage line Vdata, a second electrode of the data writing transistor Tj is electrically connected to an input electrode of the driving transistor T0, and a gate of the data writing transistor Tj is electrically connected to a data writing control signal line Sj; additionally or alternatively, the light-emitting control circuit 130 comprises a first light-emitting control transistor Tf1 and a second light-emitting control transistor Tf2, a first electrode of the first light-emitting control transistor Tf1 is electrically connected to the first power supply voltage line PVDD, a second electrode of the first light-emitting control transistor Tf1 is electrically connected to the input electrode of the driving transistor T0, a first electrode of the second light-emitting control transistor Tf2 is electrically connected to the output electrode of the driving transistor T0, a second electrode of second light-emitting control transistor Tf2 is electrically connected to the anode of the light-emitting element 12. The turning on type of the first light-emitting control transistor Tf1 and the second light-emitting control transistor Tf2 are the same, and the gate of the first light-emitting control transistor Tf1 and the gate of the second light-emitting control transistor Tf2 are both electrically connected to a light-emitting control signal line Sf. Further, the first reset circuit 140 according to the embodiments of the present application comprises a first reset transistor Tw1, a first electrode of the first reset transistor Tw1 is electrically connected to a first reset voltage line REF1, a second electrode of the first reset transistor Tw1 is electrically connected to the gate of the driving transistor T0, and a gate of the first reset transistor Tw1 is electrically connected to a first reset control signal line Sw1. The second reset circuit 150 comprises a second reset transistor Tw2, a first electrode of the second reset transistor Tw2 is electrically connected to a second reset voltage line REF2, a second electrode of the second reset transistor Tw2 is electrically connected to the anode of the light-emitting element 12, and a gate of the second reset transistor Tw2 is electrically connected to the second reset control signal line Sw2. The bias circuit 160 comprises a bias transistor Tz, a first electrode of the bias transistor Tz is electrically connected to a bias voltage line DVH, a second electrode of the bias transistor Tz is electrically connected to the input electrode of the driving transistor T0, turning on types of the bias transistor Tz and the second reset transistor Tw2 are the same, and a gate of the bias transistor Tz is electrically connected to the second reset control signal line Sw2.

It is noted that, in the embodiments of the present application, the turning on types of the first reset transistor Tw1, the second reset transistor Tw2, the first light-emitting control transistor Tf1, the second light-emitting control transistor Tf2, the threshold compensation transistor Ty, the data write transistor Tj, the bias transistor Tz, the driving transistor T0, and the potential holding transistor Td are not particularly limited, each of which may be an N-type transistor or a P-type transistor. In some embodiments, the second reset transistor Tw2, the first light-emitting control transistor Tf1, the second light-emitting control transistor Tf2, the data writing transistor Tj, the bias transistor Tz, the driving transistor T0, and the potential holding transistor Td provided in the embodiments of the present application may be P-type transistors, while the first reset transistor Tw1 and the threshold compensation transistor Ty may be N-type transistors, and the first reset transistor Tw1 and the threshold compensation transistor Ty may be oxide thin film transistors, thereby reducing the leakage current problem of the first reset transistor Tw1 and the threshold compensation transistor Ty and improving the reliability of the pixel driving circuit 11.

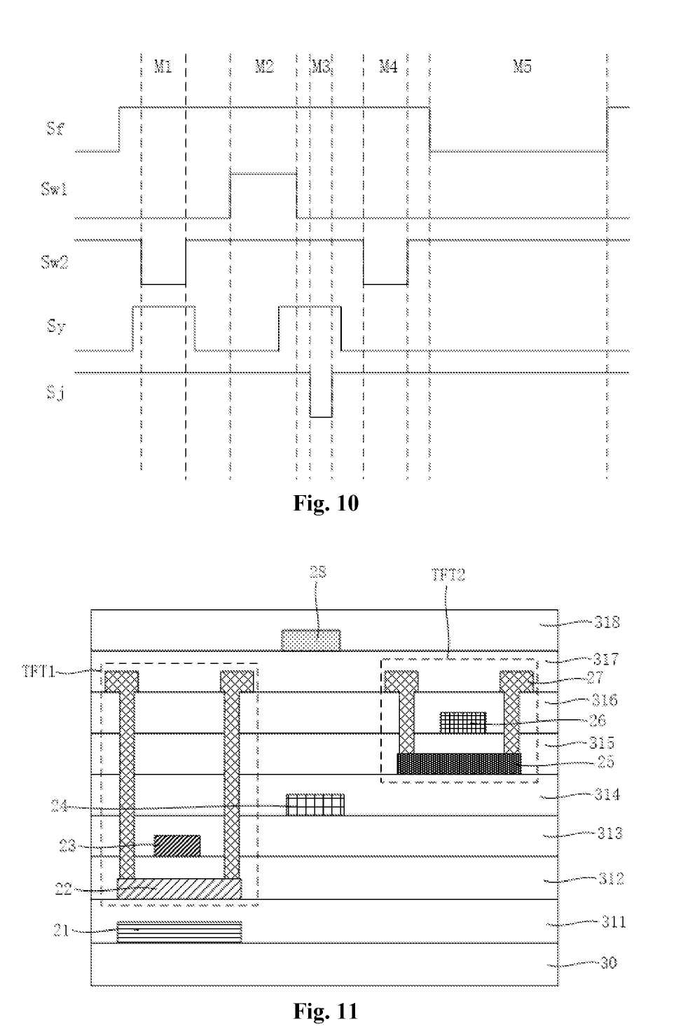

The working principle of the pixel driving circuit 11 provided by the embodiments of the present application is described with reference to a timing chart illustrated in FIG. 10, in which FIG. 10 takes the pixel driving circuit 11 illustrated in FIG. 9 as an example, the second reset transistor Tw2, the first light-emitting control transistor Tf1, the second light-emitting control transistor Tf2, the data writing transistor Tj, the bias transistor Tz, and the driving transistor T0 are P-type transistors, and the first reset transistor Tw1 and the threshold compensation transistor Ty may be N-type transistors. The operation of the pixel driving circuit 11 comprises a first bias stage M1, an initialization stage M2, a data writing and threshold compensation stage M3, a second bias stage M4, and a light-emitting stage M5, which are sequentially performed.

In the first bias stage M1, the second reset control signal line Sw2 outputs a low-level active signal, and the threshold compensation control signal line Sy outputs a high-level active signal to correspondingly control the bias transistor Tz, the second reset transistor Tw2, and the threshold compensation transistor Ty to be turned on, while the rest of the transistors are turned off, thereby achieving the purpose of bias adjustment of the driving transistor T0 and resetting the light-emitting element 12. It can be seen that due to the existence of the bias circuit 160, the threshold compensation transistor Ty is controlled to turn on or off more frequently, so that it is easier to cause heating up of the threshold compensation transistor Ty to bring about a negative bias coupling problem, and thus easier to cause a problem that the charge of the first node N1 is coupled to the second node N2 to lower the potential of the second node N2. In view of this, the pixel driver circuit 11 provided by the embodiments of the application is provided with a potential holding circuit 110 that is electrically connected to the first node N1. The potential holding circuit 110 is configured to hold the potential of the first node N1 after the threshold compensation stage, so that the problem is alleviated that the charge of the first node N1 is coupled to the second node N2 through the threshold compensation transistor Ty because of the enhancement of the negative bias coupling of the threshold compensation transistor Ty after being heated, thus avoiding the problem that the potential of the second node N2 is lowered, ensuring the accuracy of the driving current generated by the drive transistor T0, improving the reliability of the pixel drive circuit 11, avoiding the display color shift problem, and ensuring the high display quality of the display panel.

In the initialization stage M2, the first reset control signal line Tw1 outputs a high-level effective signal to correspondingly control the first reset transistor Tw1 to be turned on, thereby resetting the gate of the driving transistor T0 (that is, the second node N2), avoiding the residual voltage at the second node N2 from affecting the subsequent operation of the pixel driving circuit 11, and improving the reliability of the pixel driving circuit 11. Optionally, in the initialization stage M2, the threshold compensation control signal line Sy may also jump to a high-level active signal at the end of the stage to control the threshold compensation transistor Ty to be turned on and connect the second node N2 and the first node N1, thereby performing reset control to the first node N1, eliminating the residual voltage at the first node N1, and further improving the reliability of the pixel driving circuit 11.

In the data writing and threshold compensation stage M3, the threshold compensation control signal line Sy outputs a high-level effective signal, and the data writing control signal line Sj outputs a low-level effective signal to correspondingly control the threshold compensation transistor Ty and the data writing transistor Tj to be turned on. Through the turning-on order of the data writing transistor Tj, the driving transistor T0 and the threshold compensation transistor Ty, the data voltage output by the data voltage line Vdata is written to the second node N2, and meanwhile the threshold voltage of the driver transistor T0 is compensated to the second node N2, so as to realize the purpose of data writing and threshold compensation.

In the second bias stage M4, the second reset control signal line Sw2 outputs a low-level active signal to accordingly control the bias transistor Tz and the second reset transistor Tw2 to be turned on, thereby biasing the driving transistor T0 again and resetting the light-emitting element 12. At a time when the threshold compensation control signal line Sy jumps to a low-level inactive signal or in the first preset time before the threshold compensation control signal line Sy jumps to the low-level inactive signal in the threshold compensation stage M3, the potential holding control signal line Sd controls the potential holding transistor Td to be turned on, so that the potential holding capacitor C1 holds the potential of the first node N1, and the problem that the potential of the second node N2 is lowered is avoided, thus avoiding the problem of display color shift.

In the light-emitting stage M5, the light-emitting control signal line Sf outputs a low-level active signal to correspondingly control the first light-emitting control transistor Tf1 and the second light-emitting control transistor Tf2 to be turned on, thereby realizing a path from the first power supply voltage line PVDD to the second power supply voltage line PVEE, and controlling the driving current generated by the driving transistor T0 to be transmitted to the light-emitting element 12, so that the light-emitting element 12 is turned on in response to the driving current.

The potential holding capacitor C1 provided in the embodiments of the present application can effectively hold the potential of the first node N1, and improve the problem that the charge of the first node N1 is coupled to the second node N2 through the threshold compensation transistor Ty due to the enhanced negative bias coupling of the threshold compensation transistor Ty after being heated. The potential holding capacitor C1 can be prepared by reusing the original structural layer in the display panel. Optionally, in a direction perpendicular to the plane where the display panel is located, the display panel provided in the embodiments of the present application comprises a shielding metal layer 21, a first semiconductor layer 22, a first gate metal layer 23, a capacitor metal layer 24, a second semiconductor layer 25, a second gate metal layer 26, a source-drain metal layer 27, and a wiring metal layer 28, which are arranged sequentially; alternatively, in the direction perpendicular to the plane where the display panel is located, the display panel provided in the embodiments of the present application comprises a shielding metal layer 21, a first gate metal layer 23, a first semiconductor layer 22, a capacitor metal layer 24, a second gate metal layer 26, a second semiconductor layer 25, a source-drain metal layer 27, and a wiring metal layer 28, which are arranged sequentially. At least one electrode plate of the potential holding capacitor C1 is located in at least one of the shielding metal layer 21, the first semiconductor layer 22, the first gate metal layer 23, the capacitor metal layer 24, the second semiconductor layer 25, the second gate metal layer 26, the source-drain metal layer 27, or the wiring metal layer 28. Specifically, as shown in FIG. 11, which is a schematic structural diagram of a display panel provided by another embodiment of the present application, all transistors provided by the embodiment of the present application may be top-gate transistors, and the display panel comprises: a substrate 30; a shielding metal layer 21 on a surface of the substrate 30; a first insulating layer 311 located on a side of the shielding metal layer 21 away from the substrate 30; a first semiconductor layer 22 located on a side of the first insulating layer 311 away from the substrate 30 and comprising an active layer for forming a first-type transistor TFT1; a second insulating layer 312 located on a side of the first semiconductor layer 22 away from the substrate 30; a first gate metal layer 23 located on a side of the second insulating layer 312 away from the substrate 30 and comprising a gate electrode for forming the first type transistor TFT1; a third insulating layer 313 located on a side of the first gate metal layer 23 away from the substrate 30; a capacitive metal layer 24 located on a side of the third insulating layer 313 away from the substrate 30; a fourth insulating layer 314 located on a side of the capacitive metal layer 24 away from the substrate 30; a second semiconductor layer 25 located on a side of the fourth insulating layer 314 away from the substrate 30 and comprising an active layer for forming a second-type transistor TFT2; a fifth insulating layer 315 located on a side of the second semiconductor layer 25 away from the substrate 30; a second gate metal layer 26 located on a side of the fifth insulating layer 315 away from the substrate 30 and comprising a gate electrode for forming the second type transistor TFT2; a sixth insulating layer 316 located on a side of the second gate metal layer 26 away from the substrate 30; a source-drain metal layer 27 located on a side of the sixth insulating layer 316 away from the substrate 30 and comprising a source electrode and a drain electrode for forming the first type transistor TFT1, and a source electrode and a drain electrode forming the second type transistor TFT2; a seventh insulating layer 317 located on a side of the source-drain metal layer 27 away from the substrate 30; a wiring metal layer 28 located on the side of the seventh insulating layer 317 away from the substrate 30; and an eighth insulating layer 318 located on a side of the wiring metal layer 28 away from the substrate 30.

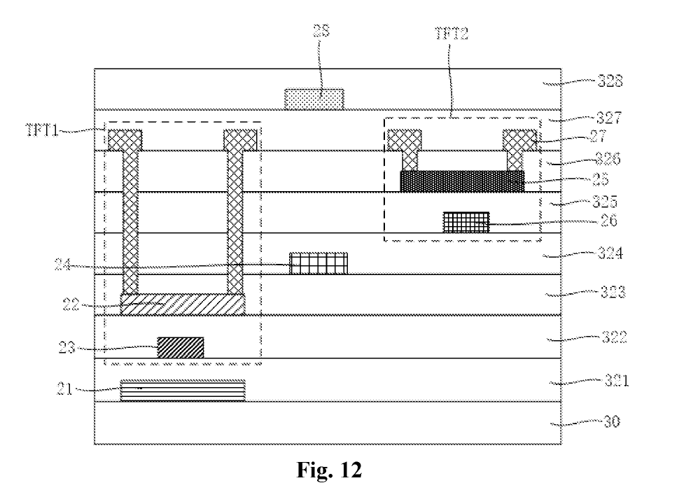

In some embodiments, the first semiconductor layer 22 provided by the embodiment of the present application may be a low-temperature polysilicon semiconductor layer, and the second semiconductor layer 25 may be an oxide semiconductor layer, the first type transistor TFT1 may be used to prepare the second reset transistor Tw2, the first light-emitting control transistor Tf1, the second light-emitting control transistor Tf2, the data writing transistor Tj, the bias transistor Tz, the driving transistor T0, and the potential holding transistor Td, and the second type transistor TFT2 may be used to prepare the first reset transistor Tw1 and the threshold compensation transistor Td, which are not limited by the present application. The first type transistor TFT1 and the second type transistor TFT2 provided in the embodiments of the present application may both be top-gate transistors shown in FIG. 11. Alternatively, the first type transistor TFT1 and the second type transistor TFT2 provided in the embodiments of the present application may both be bottom-gate transistors; specifically, as shown in FIG. 12, which is a schematic structural diagram of a display panel provided by another embodiment of the present application, all transistors provided by the embodiment of the present application may be bottom-gate transistors, and the display panel comprises: a substrate 30; a shielding metal layer 21 on a surface of the substrate 30; a first insulating layer 321 located on a side of the shielding metal layer 21 away from the substrate 30; a first gate metal layer 23 located on a side of the first insulating layer 321 away from the substrate 30, the first gate metal layer 23 comprises a gate electrode forming a first type transistor TFT1; a second insulating layer 322 located on a side of the first gate metal layer 23 away from the substrate 30; a first semiconductor layer 22 located on a side of the second insulating layer 322 away from the substrate 30, the first semiconductor layer 22 comprises an active layer forming the first type transistor TFT1; a third insulating layer 323 located on a side of the first semiconductor layer 22 away from the substrate 30; a capacitive metal layer 24 located on a side of the third insulating layer 323 away from the substrate 30; a fourth insulating layer 324 located on a side of the capacitive metal layer 24 away from the substrate 30; a second gate metal layer 26 located on a side of the fourth insulating layer 324 away from the substrate 30, the second gate metal layer 26 comprises a gate electrode forming a second type transistor TFT2; a fifth insulating layer 325 located on a side of the second gate metal layer 26 away from the substrate 30; a second semiconductor layer 25 located on a side of the fifth insulating layer 325 away from the substrate 30, the second semiconductor layer 25 comprises an active layer forming the second type transistor TFT2; a sixth insulating layer 326 located on a side of the second semiconductor layer 25 away from the substrate 30; a source-drain metal layer 27 located on a side of the sixth insulating layer 326 away from the substrate 30, the source-drain metal layer 27 comprises a source electrode and a drain electrode forming the first type transistor TFT1, and a source electrode and a drain electrode forming the second type transistor TFT2; a seventh insulating layer 327 located on a side of the source-drain metal layer 27 away from the substrate 30; a wiring metal layer 28 located on a side of the seventh insulating layer 327 away from the substrate 30; and an eighth insulating layer 328 located on a side of the wiring metal layer 28 away from the substrate 30.

It should be noted that, in the display panel provided by the embodiments of the present application, the first type transistor TFT1 and the second type transistor TFT2 may both be top-gate transistors, or the first type transistor TFT1 and the second type transistor TFT2 may both be bottom-gate transistors. Alternatively, the first type transistor TFT1 may be a top-gate transistor, and the second type transistor TFT2 may be a bottom-gate transistor (i.e., in the display panel, the first semiconductor layer 22 is located between the shielding metal layer 21 and the first gate metal layer 23, and the second semiconductor layer 22 is located between the second gate metal layer 26 and the source-drain metal layer 27); alternatively, the first type transistor TFT1 may be a bottom-gate transistor, and the second type transistor TFT2 may be a top-gate transistor (that is, in the display panel, the first semiconductor layer 22 is located between the first gate metal layer 22 and the capacitor metal layer 24, and the second semiconductor layer 25 is located between the capacitor metal layer 24 and the second gate metal layer 26), which are not specifically limited in this application, and needs to be specifically designed according to practical applications. Optionally, the material of all the insulating layers provided in the embodiments of the present application may be nitride or oxide, such as silicon nitride or silicon oxide.

In some embodiments, the display panel provided by the embodiments of the present application may comprise pixel units Pi of a plurality of colors, and the light-emitting colors of the light-emitting elements 12 electrically connected to the pixel driving circuits 11 in the pixel units Pi of different colors are different. Herein, since the light-emitting efficiencies of the pixel units Pi of different colors are different, the driving currents generated by the driving transistors T0 in the different pixel units Pi are also different, resulting in a difference in the degree to which the potentials of the second nodes N2 of the pixel units Pi of different colors are lowered. That is, the driving current required for the pixel unit Pi having a lower light-emitting efficiency is greater, so that the potential of the second node N2 of the pixel unit Pi having a lower light-emitting efficiency is lowered to a greater extent, and the problem of causing color shift is more serious. In the pixel units Pi of different colors provided in the embodiment of the present application, the capacitance of the potential holding capacitor C1 of the pixel unit Pi having lower light-emitting efficiency is set to be greater than the capacitance of the potential holding capacitor C1 of the pixel unit Pi having higher light-emitting efficiency, thereby improving the problem that the potential of the second node N2 of the pixel unit Pi having lower light-emitting efficiency is largely lowered, and thus avoiding the problem of display color shift. Optionally, the pixel driving circuit 11 provided in the embodiments of the present application comprises a first-type pixel driving circuit 111 electrically connected to a blue light-emitting element and a second-type pixel driving circuit 112 electrically connected to a red light-emitting element or a green light-emitting element. The capacitance value of the potential holding capacitor C1 of the first-type pixel driving circuit 111 is greater than the capacitance value of the potential holding capacitor C1 of the second-type pixel driving circuit 112. Furthermore, the pixel driving circuit 11 according to the embodiments of the present application comprises a third-type pixel driving circuit 113 electrically connected to the red light-emitting element or the green light-emitting element, and the light-emitting colors of the light-emitting elements electrically connected to the second-type pixel driving circuit 112 and the third-type pixel driving circuit 113 are different. The capacitance value of the potential holding capacitor C1 of the pixel driving circuit electrically connected to the red light-emitting element is greater than the capacitance value of the potential holding capacitor C1 of the pixel driving circuit electrically connected to the green light-emitting element.

It will be appreciated that the plurality of pixel units Pi provided in the embodiments of the present application may comprise a blue light pixel unit, a red light pixel unit, and a green light pixel unit, the pixel driving circuit 11 in the blue light pixel unit is electrically connected to the blue light-emitting element, the pixel driving circuit 11 in the red light pixel unit is electrically connected to the red light-emitting element, and the pixel driving circuit 11 in the green light pixel unit is electrically connected to the green light-emitting element. Since the light-emitting efficiency of the blue pixel unit is significantly lower than that of the red pixel unit, and far lower than that of the green pixel unit, in order to balance the degree to which the second node N2 of the pixel driving circuit 11 in the blue pixel unit, the red pixel unit, and the green pixel unit are lowered, the capacitance value of the potential holding capacitor C1 of the blue pixel unit provided by the embodiments of the present application is greater than that of the red pixel unit; the capacitance value of the potential holding capacitor C1 of the blue pixel unit is greater than that of the green pixel unit; and the capacitance value of the potential holding capacitor C1 of the red light pixel unit may be set to be greater than the capacitance value of the potential holding capacitor C1 of the green light pixel unit, or the capacitance value of the potential holding capacitor C1 of the red light pixel unit may be set to be equal to the capacitance value of the potential holding capacitor C1 of the green light pixel unit, which are not specifically limited in the present application.

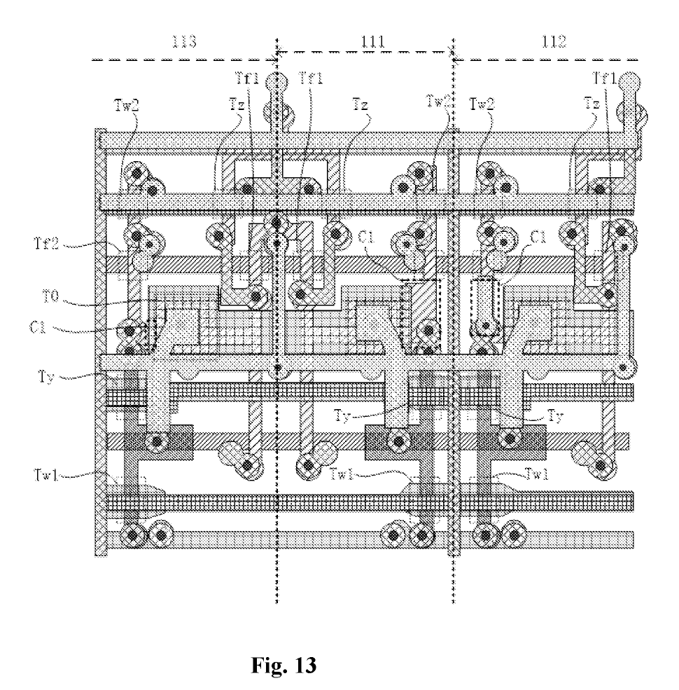

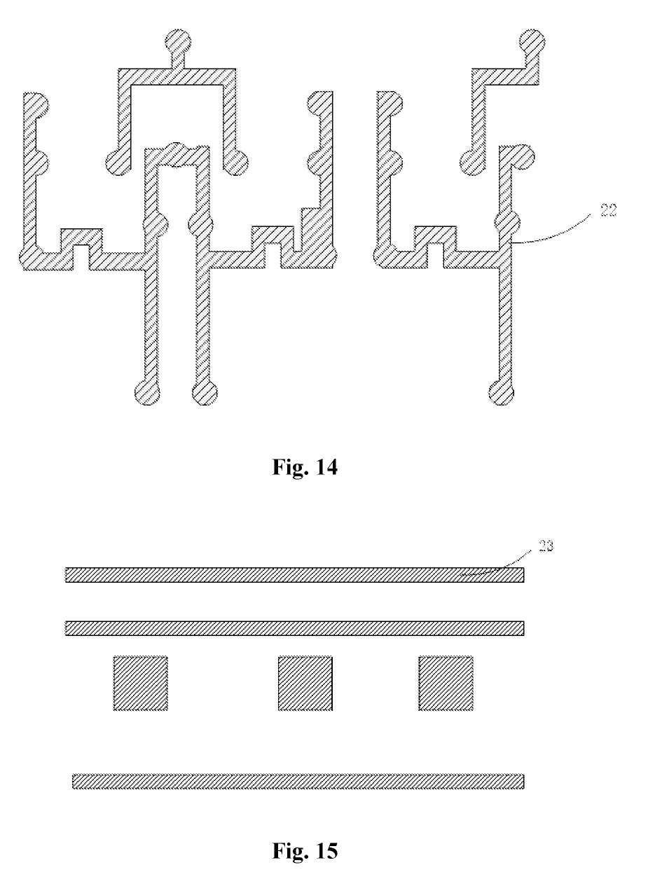

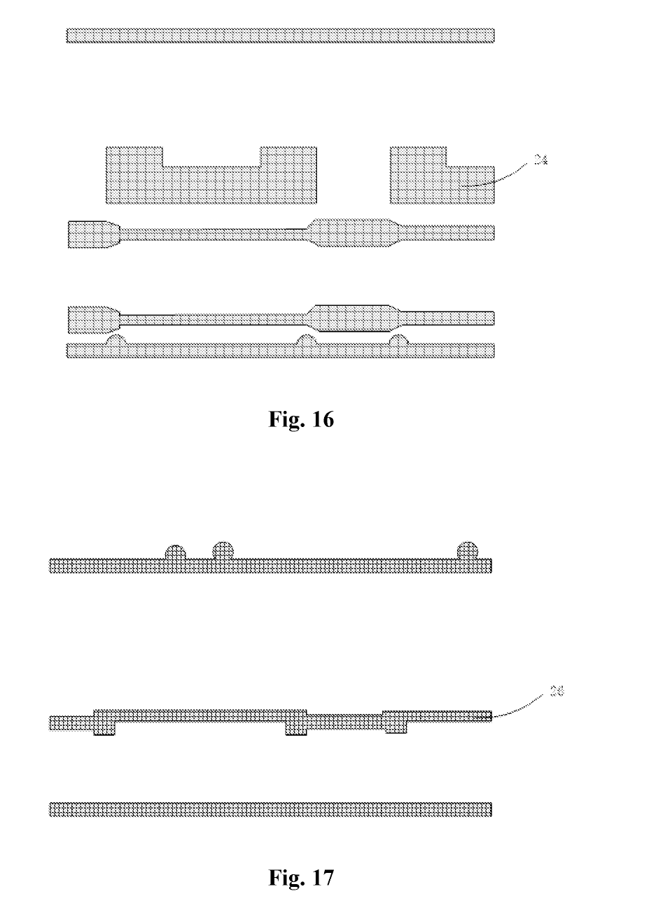

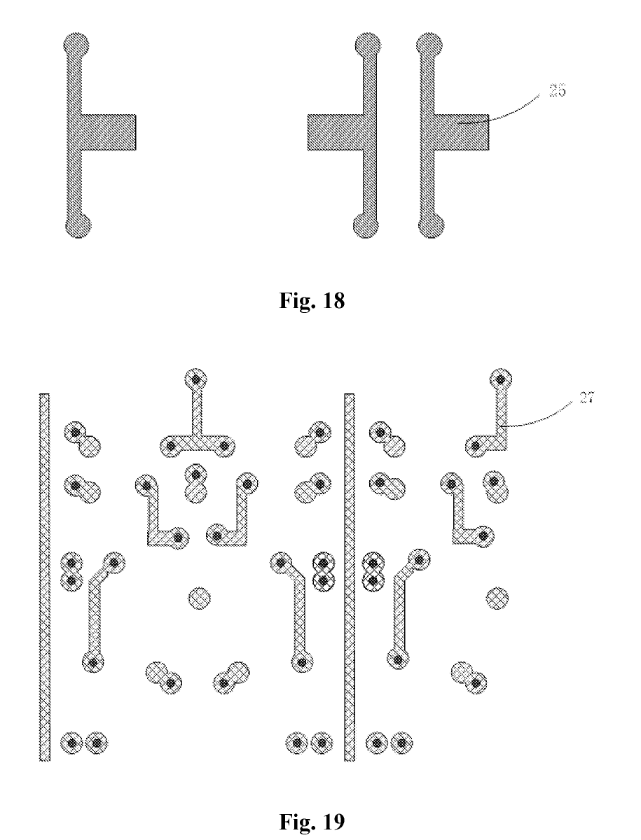

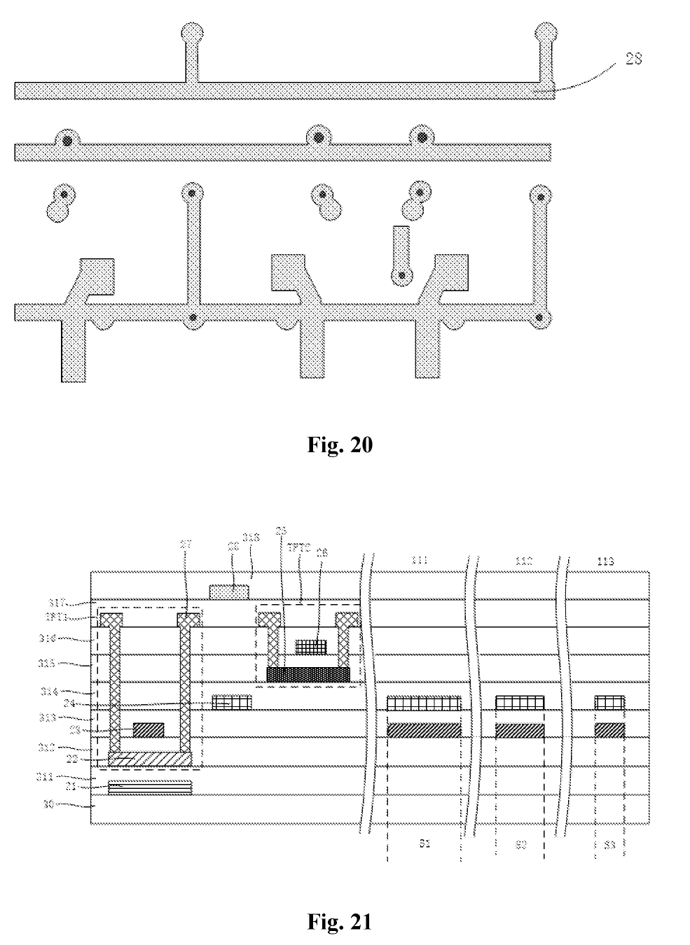

Referring specifically to FIGS. 13 to 20, FIG. 13 is a part of a layout of a pixel driving circuit provided by an embodiment of the present application, FIG. 14 is a schematic structural diagram of a first semiconductor layer in FIG. 13, FIG. 15 is a schematic structural diagram of a first gate metal layer in FIG. 13; FIG. 16 is a schematic structural diagram of a capacitor metal layer of FIG. 13; FIG. 17 is a schematic structural diagram of a second gate metal layer in FIG. 13; FIG. 18 is a schematic structural diagram of a second semiconductor layer in FIG. 13; FIG. 19 is a schematic structural diagram of a source-drain metal layer in FIG. 13; and FIG. 20 is a schematic structural diagram of a wiring metal layer in FIG. 13. One blue light pixel unit, one green light pixel unit, and one red light pixel unit adjacent to each other in the display panel may form a pixel dot, the first-type pixel driving circuit 111 is electrically connected to the blue light-emitting element, the second-type pixel driving circuit 112 is electrically connected to the red light-emitting element, and the third-type pixel driving circuit 113 is electrically connected to the green light-emitting element. In order to balance the degree to which the second nodes N2 of the pixel driving circuits 11 are lowered in the blue pixel unit, the red pixel unit, and the green pixel unit, the capacitance value of the potential holding capacitor C1 of the first-type pixel driving circuit 111 provided by the embodiments of the present application is greater than the capacitance value of the potential holding capacitor C1 of the second-type pixel driving circuit 112, the capacitance value of the potential holding capacitor C1 of the first-type pixel driving circuit 111 is greater than the capacitance value of the potential holding capacitor C1 of the third-type pixel driving circuit 113, and the capacitance value of the potential holding capacitor C1 of the second-type pixel driving circuit 112 may be set to be greater than the capacitance value of the potential holding capacitor C1 of the third-type pixel driving circuit 113, or the capacitance value of the potential holding capacitor C1 of the second-type pixel driving circuit 112 may be set to be equal to the capacitance value of the potential holding capacitor C1 of the third-type pixel driving circuit 113, which are not specifically limited in the present application. When the first-type pixel driving circuit 111 is electrically connected to the blue light-emitting element, the second-type pixel driving circuit 112 is electrically connected to the red light-emitting element, and the third-type pixel driving circuit 113 is electrically connected to the green light-emitting element, the ratio of the capacitance value B of the potential holding capacitor C1 of the first-type pixel driving circuit 111, the capacitance value R of the potential holding capacitor C1 of the second-type pixel driving circuit 112 and the capacitance value G of the third-type pixel driving circuit 113 B: R: G may be a: b: 1, where a and b are both greater than 1 and less than or equal to 100, and a is greater than b, which are not specifically limited in the present application.

In some embodiments, in order to adjust the capacitance value of the potential holding capacitor C1, an overlap area of plates of the potential holding capacitor C1 may be adjusted. Specifically, according to the embodiments of the present application, the first-type pixel driving circuit 111 is electrically connected to the blue light-emitting element, the second-type pixel driving circuit 112 is electrically connected to the red light-emitting element, and the third-type pixel driving circuit 113 is electrically connected to the green light-emitting element, an overlapping area of the first plate and the second plate of the potential holding capacitor C1 of the first-type pixel driving circuit 111 is greater than an overlapping area of the first plate and the second plate of the potential holding capacitor C1 of the second-type pixel driving circuit 112; additionally or alternatively, an overlapping area of the first plate and the second plate of the potential holding capacitor C1 of the second-type pixel driving circuit 112 is greater than an overlapping area of the first plate and the second plate of the potential holding capacitor C1 of the third-type pixel driving circuit 113. Specifically, as shown in FIG. 21, which is a schematic structural diagram of a display panel provided by another embodiment of the present application, taking an example that two plates of all potential holding capacitors C1 are respectively located in the first gate metal layer 23 and the capacitor metal layer 24, in the embodiment of the present application, an overlapping area S1 of the first plate and the second plate of the potential holding capacitor C1 of the first-type pixel driving circuit 111 is greater than an overlapping area S2 of the first plate and the second plate of the potential holding capacitor C1 of the second-type pixel driving circuit 112; the overlapping area S1 of the first plate and the second plate of the potential holding capacitor C1 of the first-type pixel driving circuit 111 is greater than an overlapping area S3 of the first plate and the second plate of the potential holding capacitor C1 of the third-type pixel driving circuit 113; and, the overlapping area S2 of the first plate and the second plate of the potential holding capacitor C1 of the second-type pixel driving circuit 112 is greater than the overlapping area S3 of the first plate and the second plate of the potential holding capacitor C1 of the third-type pixel driving circuit 113, thereby realizing a solution in which the capacitance value of the potential holding capacitor C1 of the first-type pixel driving circuit 111 is greater than that of the second-type pixel driving circuit 112, and the capacitance value of the potential holding capacitor C1 of the second-type pixel driving circuit 112 is greater than that of the third-type pixel driving circuit 113.

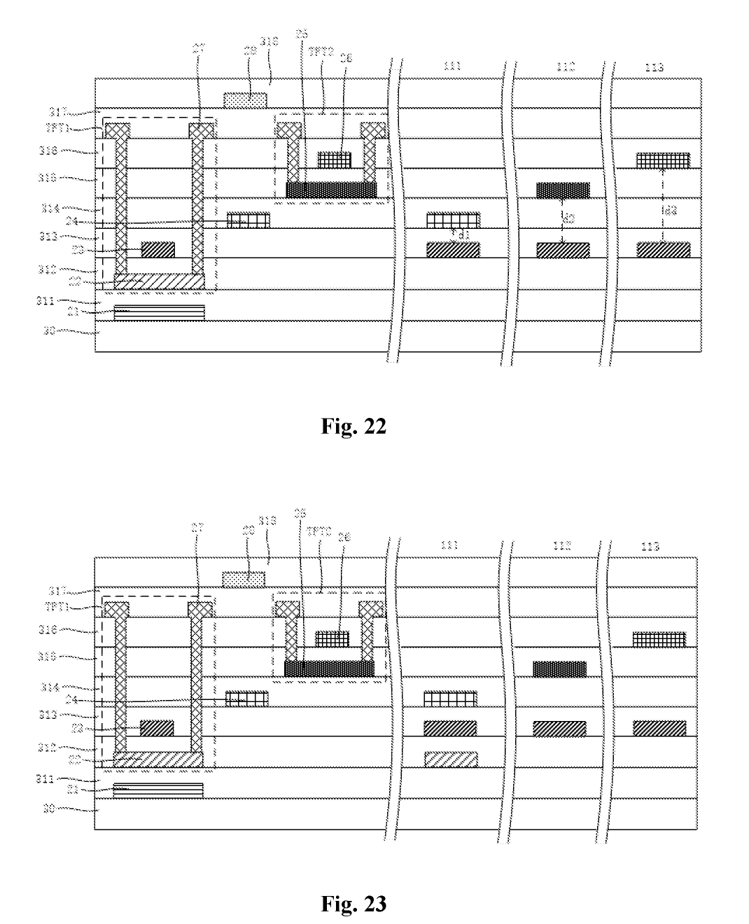

Alternatively, in order to adjust the capacitance value of the potential holding capacitor C1, a distance between the plates of the potential holding capacitor C1 may be adjusted. Specifically, according to the embodiments of the present application, the first-type pixel driving circuit 111 is electrically connected to the blue light-emitting element, the second-type pixel driving circuit 112 is electrically connected to the red light-emitting element, and the third-type pixel driving circuit 113 is electrically connected to the green light-emitting element, a distance between the first plate and the second plate of the potential holding capacitor C1 of the first-type pixel driving circuit 111 is smaller than a distance between the first plate and the second plate of the potential holding capacitor C1 of the second-type pixel driving circuit 112; additionally or alternatively, the distance between the first plate and the second plate of the potential holding capacitor of the second-type pixel driving circuit 112 is smaller than the distance between the first plate and the second plate of the potential holding capacitor of the third-type pixel driving circuit 113. Referring specifically to FIG. 22, which is a schematic structural diagram of a display panel provided by yet another embodiment of the present application, when the overlapping areas of the two plates of the potential holding capacitor C1 of the first-type pixel driving circuit 111, the second-type pixel driving circuit 112, and the third-type pixel driving circuit 113 are the same, the two plates of the potential holding capacitor C1 of the first-type pixel driving circuit 111 provided by the embodiments of the present application are respectively located in the first gate metal layer 23 and the capacitor metal layer 24, and the distance between the two plates of the potential holding capacitor C1 of the first-type pixel driving circuit 111 is d1; the two plates of the potential holding capacitor C1 of the second-type pixel driving circuit 112 are respectively located in the first gate metal layer 23 and the second semiconductor layer 25, and the distance between the two plates of the potential holding capacitor C1 of the second-type pixel driving circuit 112 is d2; and the two plates of the potential holding capacitor C1 of the third pixel driving circuit 112 are respectively located in the first gate metal layer 23 and the second gate metal layer 26, and the distance between the two plates of the potential holding capacitor C1 of the third pixel driving circuit 112 is d3, where d1 is smaller than d2 and d2 is smaller than d3, thereby realizing a solution in which the capacitance value of the potential holding capacitor C1 of the first-type pixel driving circuit 111 is greater than that of the second-type pixel driving circuit 112, and the capacitance value of the potential holding capacitor C1 of the second-type pixel driving circuit 112 is greater than that of the third-type pixel driving circuit 113.

It should be noted that the capacitance value adjustment ways of the potential holding capacitor C1 illustrated in FIGS. 21 and 22 provided in the embodiments of the present application are only two of all the adjustment ways applicable to the present application. In some other embodiments, an overlapping area of the two plates of the potential holding capacitor C1 may be individually adjusted, or the distance between the two plates of the potential holding capacitor C1 may be individually adjusted; alternatively, the overlapping area of and the distance between the two plates of the potential holding capacitor C1 may be adjusted collaboratively, and the present application does not specifically limit this. In some embodiments, in the technical solution provided by the embodiments of the present application, when the overlapping area of the two plates of the potential holding capacitor C1 is adjusted, one of the plates may be set as at least two sub-plates of different structural layers, and the purpose of adjusting the overlapping area of the two plates of the potential holding capacitor C1 can be achieved by overlapping the at least two sub-plates with the other plate. Specifically, as shown in FIG. 23, which is a schematic structural diagram of a display panel provided by another embodiment of the present application, the pixel driving circuit provided by the embodiment of the present application comprises a first-type pixel driving circuit 111 electrically connected to a blue light-emitting element. The first plate of the potential holding capacitor C1 of the first-type pixel driving circuit 111 comprises at least two sub-plates, such as a first sub-plate B11 located in the first semiconductor layer 22 and a second sub-plate B12 located in a constant volume metal layer 24. In a direction Y perpendicular to the plane where the display panel is located, at least one of the sub-plates corresponds to a side of the second plate B2, thereby achieving the purpose of increasing the capacitance value of the potential holding capacitor C1 of the first-type pixel driving circuit 111.

Referring to FIG. 25, which is a schematic structural diagram of a display panel provided by another embodiment of the present application, an active layer of the driving transistor T0 provided by the embodiments of the present application is located in the first semiconductor layer 22; the first plate B1 of the potential holding capacitor C1 may be located in the capacitor metal layer 24, the second plate B2 of the potential holding capacitor C1 may be located in the first semiconductor layer 22, and the second plate B2 of the potential holding capacitor C1 extends in contact with the active layer of the driving transistor T0, thereby realizing the purpose of the second plate of the potential holding capacitor C1 electrically connecting to the output electrode of the driving transistor T0 at the first node N1, avoiding the second plate of the potential holding capacitor C1 electrically connecting to the output electrode of the driving transistor T0 by via holes, simplifying the manufacturing process of the display panel, and improving the manufacturing yield of the display panel.

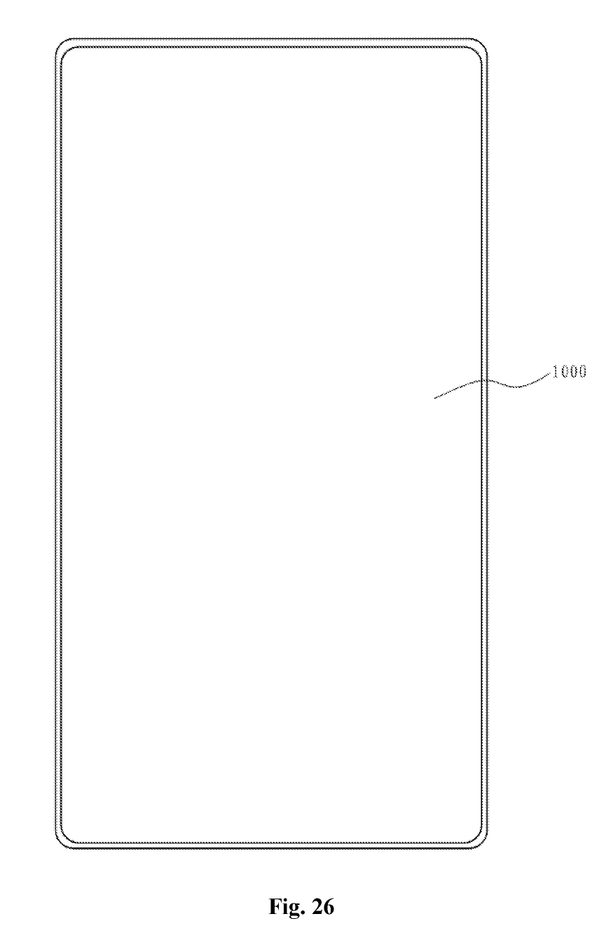

Based on the same inventive concept, embodiments of the present application further provide an electronic device. Referring to FIG. 26, which is a schematic structural diagram of an electronic device provided by an embodiment of the present application, the electronic device 1000 provided by an embodiment of the present application comprises a display panel provided by any one of the above embodiments, or comprises a spliced display screen provided by any one of the above embodiments.

In some embodiments, the electronic device 1000 provided by the embodiments of the present application may be a large or small device such as a mobile terminal, a notebook, a tablet computer, a computer, or a wearable device, and the present application does not specifically limit this.

In summary, embodiments of the present application provide a display panel and an electronic device, the display panel comprises a plurality of pixel driving circuits, and the pixel driving circuit comprises: a driving transistor configured for generating a driving current; a threshold compensation transistor, a first electrode of the threshold compensation transistor is electrically connected to an output electrode of the driving transistor at a first node, a second electrode of the threshold compensation transistor is electrically connected to a gate of the driving transistor at a second node, and a gate of the threshold compensation transistor is electrically connected to a threshold compensation control signal line; a potential holding circuit electrically connected to the first node. As can be seen from the above, according to the technical solutions provided by the embodiments of the present application, the pixel driving circuit is provided with a potential holding circuit electrically connected to the first node, and the potential holding circuit can hold the potential of the first node, thereby improving the problem that the charge of the first node is coupled to the second node through the threshold compensation transistor due to the enhanced negative bias coupling of the threshold compensation transistor after being heated, avoiding the problem that the potential of the second node is lowered, ensuring the accuracy of the driving current generated by the driving transistor, improving the reliability of the pixel driving circuit, and ensuring high display effect of the display panel.

In the description of the embodiments of the present application, it should be understood that the orientation or positional relationships indicated by the terms "center", "longitudinal", "transverse", "length", "width", "thickness", "upper", "lower", "front", "back", "left", "right", "vertical", "horizontal", "top", "bottom", "inner", "outer", "clockwise", "counterclockwise", "axial", "radial", "circumferential", etc. are based on the orientation or positional relationships shown in the drawings. The purpose is only to facilitate the description of the embodiments of this application and to simplify the description, and is not to indicate or imply that the device or component in question must have a particular orientation, be constructed and operate in a particular orientation, and therefore shall not be construed as a limitation of this Application.

Furthermore, the terms "first" and "second", as they appear, are for descriptive purposes only, and are not to be understood as indicating or implying relative importance or the number of technical features indicated. Thus, a feature defined as "first" or "second" may explicitly or implicitly comprise at least one of the features. In the description of the embodiments of the present application, "a plurality" means at least two, for example, two, three, etc. unless otherwise specifically defined.

In the embodiments of the present application, unless otherwise explicitly specified and limited, such terms as "mounted", "connected", "coupled", and "fixed" should be understood in a broad sense, for example, they may be fixed connected, detachable connected, or integrated; may be mechanically connected or electrically connected or communicable with each other; it can be directly connected, or indirectly connected through an intermediate medium, and it can be the internal communication of two elements or the interaction of two elements, unless otherwise explicitly defined. Those skilled in the art can understand the specific meanings of the above-mentioned terms in the present application according to the specific circumstances.

In embodiments of the present application, unless otherwise explicitly specified and defined, the first feature "above" or "below" the second feature may be in direct contact with the first and second features, or the first and second features may be in indirect contact with the first and second features through an intermediate medium. Furthermore, the first feature being "above", "upward" and "on top of" the second feature may be the first feature being directly above or obliquely above the second feature, or simply mean that the horizontal height of the first feature is higher than that of the second feature. The first feature being "below", "downward" and "under" the second feature may mean that the first feature is directly below or obliquely below the second feature, or simply mean that the horizontal height of the first feature is lower than that of the second feature.

In embodiments of the present application, when the terms "one embodiment," "some embodiments," "examples," "specific examples," or "some examples" appear, it means that a specific feature, structure, material, or characteristic described in connection with the embodiment or example is comprised in at least one embodiment or example of the present application. In the present specification, schematic expressions of the above-described terms are not necessarily directed to the same embodiments or examples. Moreover, the specific features, structures, materials, or features described may be combined in any one or more embodiments or examples in a suitable manner. Furthermore, those skilled in the art can combine different embodiments or examples described in this specification and features of different embodiments or examples without contradicting each other.

Although the embodiments of the present application have been shown and described above, it is to be understood that the above embodiments are exemplary and should not be understood as limitations of the present application, and those skilled in the art can make changes, modifications, substitutions and modifications to the above embodiments within the scope of the present application.

What is claimed is:

1. A display panel, comprising a plurality of pixel driving circuits, wherein the pixel driving circuit comprises:
a driving transistor configured for generating a driving current;
a threshold compensation transistor, a first electrode of the threshold compensation transistor being electrically connected to an output electrode of the driving transistor at a first node, a second electrode of the threshold compensation transistor being electrically connected to a gate of the driving transistor at a second node, and a gate of the threshold compensation transistor being electrically connected to a threshold compensation control signal line; and
a potential holding circuit electrically connected to the first node.

2. The display panel according to claim 1, wherein the potential holding circuit comprises a potential holding capacitor, a first plate of the potential holding capacitor being electrically connected to a reference voltage line, and a second plate of the potential holding capacitor being electrically connected to the first node.

3. The display panel according to claim 2, wherein the potential holding circuit further comprises a potential holding transistor, a first electrode of the potential holding transistor being electrically connected to the second plate of the potential holding capacitor, a second electrode of the potential holding transistor being electrically connected to the first node, and a gate of the potential holding transistor being electrically connected to a potential holding control signal line.

4. The display panel according to claim 3, wherein the potential holding control signal line is configured to control the potential holding transistor to be turned on when the threshold compensation control signal line controls the threshold compensation transistor to be turned off after completing threshold compensation, or
the potential holding control signal line is configured to control the potential holding transistor to be turned on within a first preset time before the threshold compensation control signal line controls the threshold compensation transistor to be turned off after completing threshold compensation.

5. The display panel according to claim 3, wherein the potential holding control signal line is configured to control the potential holding transistor to be turned off while the pixel driving circuit drives a light-emitting element electrically connected thereto to emit light; or
the potential holding control signal line is configured to control the potential holding transistor to be turned off within a second preset time before the pixel driving circuit drives the light-emitting element to emit light.

6. The display panel according to claim 2, wherein
the plurality of pixel driving circuits comprise a first-type pixel driving circuit electrically connected to a blue light-emitting element, and a second-type pixel driving circuit electrically connected to a red light-emitting element or a green light-emitting element, and
a capacitance value of the potential holding capacitor of the first-type pixel driving circuit is greater than a capacitance value of the potential holding capacitor of the second-type pixel driving circuit.

7. The display panel according to claim 6, wherein
the plurality of pixel driving circuits comprise a third-type pixel driving circuit electrically connected to the red light-emitting element or the green light-emitting element, and the light-emitting colors of the light-emitting elements electrically connected to the second pixel driving circuit and the third pixel driving circuit are different, and
a capacitance value of the potential holding capacitor of the pixel driving circuit electrically connected to the red light-emitting element is greater than a capacitance value of the potential holding capacitor of the pixel driving circuit electrically connected to the green light-emitting element.

8. The display panel according to claim 7, wherein the first-type pixel driving circuit is electrically connected to the blue light-emitting element, the second-type pixel driving circuit is electrically connected to the red light-emitting element, and the third-type of pixel driving circuit is electrically connected to the green light-emitting element; and
an overlapping area of the first plate and the second plate of the potential holding capacitor of the first-type pixel driving circuit is greater than an overlapping area of the first plate and the second plate of the potential holding capacitor of the second-type pixel driving circuit;
and/or an overlapping area of the first plate and the second plate of the potential holding capacitor of the second-type pixel driving circuit is greater than an overlapping area of the first plate and the second plate of the potential holding capacitor of the third-type pixel driving circuit;
and/or a distance between the first plate and the second plate of the potential holding capacitor of the first-type pixel driving circuit is smaller than a distance between the first plate and the second plate of the potential holding capacitor of the second-type pixel driving circuit;
and/or a distance between the first plate and the second plate of the potential holding capacitor of the second-type of pixel driving circuit is smaller than a distance between the first plate and the second plate of the potential holding capacitor of the third-type pixel driving circuit.

9. The display panel according to claim 7, wherein the first-type pixel driving circuit is electrically connected to the blue light-emitting element, the second-type pixel driving circuit is electrically connected to the red light-emitting element, and the third-type pixel driving circuit is electrically connected to the green light-emitting element; and
a ratio B: R: G of the capacitance value B of the potential holding capacitor of the first-type pixel driving circuit, the capacitance value R of the potential holding capacitor of the second-type pixel driving circuit, and the capacitance value G of the potential holding capacitor of the third-type pixel driving circuit is a: b: 1, where values of a and b are both greater than 1 and less than or equal to 100, and a is greater than b.

10. The display panel according to claim 2, wherein the display panel comprises a shielding metal layer, a first semiconductor layer, a first gate metal layer, a capacitor metal layer, a second semiconductor layer, a second gate metal layer, a source-drain metal layer, and a wiring metal layer arranged sequentially in a direction perpendicular to a plane where the display panel is located, or, the display panel comprises a shielding metal layer, a first gate metal layer, a first semiconductor layer, a capacitor metal layer, a second gate metal layer, a second semiconductor layer, a source-drain metal layer and a wiring metal layer arranged sequentially in the direction perpendicular to the plane where the display panel is located; and
at least one plate of the potential holding capacitor is located in at least one of the shielding metal layer, the first semiconductor layer, the first gate metal layer, the capacitor metal layer, the second semiconductor layer, the second gate metal layer, the source-drain metal layer, or the wiring metal layer.

11. The display panel according to claim 10, wherein an active layer of the driving transistor is located in the first semiconductor layer;
the second plate of the potential holding capacitor is located in the first semiconductor layer, and extends to be in contact and communicate with the active layer of the driving transistor.

12. The display panel according to claim 10, wherein the pixel driving circuit comprises a first-type pixel driving circuit electrically connected to the blue light-emitting element;
a first plate of the potential holding capacitor of the first-type pixel driving circuit comprises at least two sub-plates; and
in the direction perpendicular to the plane where the display panel is located, one side of the second plate corresponds to at least one of the sub-plates.

13. The display panel according to claim 1, wherein the pixel driving circuit comprises:
a storage capacitor, a first plate of the storage capacitor being electrically connected to a first power supply voltage line, and a second plate of the storage capacitor being electrically connected to the gate of the driving transistor;
a data writing circuit electrically connected to an input electrode of the driving transistor, and configured to transmit a data voltage to the driving transistor;
a light-emitting control circuit electrically connected in series with the driving transistor, and configured to control transmission of the driving current to the light-emitting element.

14. The display panel according to claim 13, wherein
the data writing circuit comprises a data writing transistor, a first electrode of the data writing transistor being electrically connected to the data voltage line, a second electrode of the data writing transistor being electrically connected to the input electrode of the driving transistor, and a gate of the data writing transistor being electrically connected to the data writing control signal line;
and/or the light-emitting control circuit comprises a first light-emitting control transistor and a second light-emitting control transistor, a first electrode of the first light-emitting control transistor being electrically connected to a first power supply voltage line, a second electrode of the first light-emitting control transistor being electrically connected to the input electrode of the driving transistor, a first electrode of the second light-emitting control transistor being electrically connected to the output electrode of the driving transistor, a second electrode of the second light-emitting control transistor being electrically connected to an anode of the light-emitting element, and a gate of the first light-emitting control transistor and a gate of the second light-emitting control transistor being both electrically connected to a light-emitting control signal line.

15. The display panel according to claim 1, wherein the pixel driving circuit further comprises a first reset circuit electrically connected to the gate of the driving transistor, the first reset circuit being configured to transmit a first reset voltage to the gate of the driving transistor.

16. The display panel according to claim 15, wherein the first reset circuit comprises a first reset transistor, a first electrode of the first reset transistor being electrically connected to a first reset voltage line, a second electrode of the first reset transistor being electrically connected to the gate of the driving transistor, and a gate of the first reset transistor being electrically connected to a first reset control signal line.

17. The display panel according to claim 15, wherein the pixel driving circuit further comprises a second reset circuit electrically connected to the anode of the light-emitting element and configured to transmit a second reset voltage to the light-emitting element.

18. The display panel according to claim 17, wherein the second reset circuit comprises a second reset transistor, a first electrode of the second reset transistor being electrically connected to a second reset voltage line, a second electrode of the second reset transistor being electrically connected to the anode of the light-emitting element, and a gate of the second reset transistor being electrically connected to a second reset control signal line.

19. The display panel of claim 17, wherein the pixel driving circuit further comprises a bias circuit electrically connected to the input electrode of the driving transistor, the bias circuit being configured to transmit a bias voltage to the driving transistor, and
the bias circuit comprises a bias transistor, a first electrode of the bias transistor being electrically connected to a bias voltage line, a second electrode of the bias transistor being electrically connected to the input electrode of the driving transistor, and a gate of the bias transistor being electrically connected to the second reset control signal line.

20. An electronic device comprising the display panel, comprising a plurality of pixel driving circuits, wherein the pixel driving circuit comprises:
a driving transistor configured for generating a driving current;
a threshold compensation transistor, a first electrode of the threshold compensation transistor being electrically connected to an output electrode of the driving transistor at a first node, a second electrode of the threshold compensation transistor being electrically connected to a gate of the driving transistor at a second node, and a gate of the threshold compensation transistor being electrically connected to a threshold compensation control signal line; and
a potential holding circuit electrically connected to the first node.
